(19) United States
(12) Patent Application Publication
(10) Pub. No.: US 2024/0428401 A1
(43) Pub. Date: Dec. 26, 2024

(54) AI-BASED WORKFLOW FOR THE ASSESSMENT OF TUMORS FROM MEDICAL IMAGES

(71) Applicant: Siemens Healthineers AG, Forchheim (DE)

(72) Inventors: Bin Lou, Princeton Junction, NJ (US); Julian Rosenman, Chapel Hill, NC (US); Patrick Kupelian, Los Angeles, CA (US); Zhoubing Xu, Plainsboro, NJ (US); Sasa Grbic, Plainsboro, NJ (US); Ali Kamen, Skillman, NJ (US); Dorin Comaniciu, Princeton, NJ (US)

(21) Appl. No.: 18/339,471

(22) Filed: Jun. 22, 2023

(51) Int. Cl. G06T 7/00; G06T 7/11

(52) U.S. Cl. CPC G06T 7/0012; G06T 7/11; G06T 2207/10081; G06T 2207/20081; G06T 2207/30096

(57) ABSTRACT

Systems and methods for performing an assessment of one or more tumors are provided. A plurality of input medical images of a patient acquired at a plurality of points in time is received. One or more tumors are identified in each of the plurality of input medical images. A tumor burden of the patient is determined for each of the plurality of points in time based on the one or more identified tumors using one or more machine learning based networks. An assessment of the one or more tumors is performed based on the tumor burden of the patient determined for each of the plurality of points in time. Results of the assessment of the one or more tumors are output.

### TECHNICAL FIELD

The present invention relates generally to medical imaging analysis, and in particular to an AI (artificial intelligence)/ML (machine learning)-based workflow for the assessment of tumors from medical images.

### BACKGROUND

Treatment response of tumors of a patient is typically evaluated by comparing assessments of the tumors at various points in time. In the current clinical workflow, the treatment response of tumors is typically evaluated according to RECIST (response evaluation criteria in solid tumors). RECIST provides a standardized criteria for assessing changes in the tumor burden of the patient based on various measurements of the tumors.

Currently, measurements of tumors are typically performed manually by a radiologist, which is a cumbersome and time-consuming process. RECIST has been designed, at least in part, to facilitate such manual measurements of tumors, which has limited the accuracy of the RECIST assessment. For example, RECIST currently limits the number of measurements to a maximum of five target lesions. This may cause newly emergent tumors in a distant location to be overlooked. In another example, fast growing small tumors are not measured or tracked under RECIST, even while such fast growing small tumors may be more likely to harbor recently mutated, treatment-resistant tumor clones.

Recently, automated approaches for the measurement of tumors have been proposed. However, such automatic approaches are limited to measuring tumors located at specific anatomical sites of interest of the patient, such as, e.g., the brain, the liver, the bone, and the lungs. There are no existing solutions for the assessment of all tumors located at all anatomical sites of the patient.

### BRIEF SUMMARY OF THE INVENTION

Embodiments described herein provide for an AI/ML-based workflow for the automatic assessment of tumors from medical images. Such automatic assessment of tumors may be performed according to RECIST, an extended version of RECIST, or any other suitable criteria for the assessment of tumors.

In accordance with one or more embodiments, systems and methods for performing an assessment of one or more tumors are provided. A plurality of input medical images of a patient acquired at a plurality of points in time is received. One or more tumors are identified in each of the plurality of input medical images. A tumor burden of the patient is determined for each of the plurality of points in time based on the one or more identified tumors using one or more machine learning based networks. An assessment of the one or more tumors is performed based on the tumor burden of the patient determined for each of the plurality of points in time. Results of the assessment of the one or more tumors are output.

In one embodiment, organs are segmented from the plurality of input medical images using a machine learning based segmentation network. At least one tumor is identified within organs, soft tissue, and bones based on the segmented organs. Benign tumors are filtered out.

In one embodiment, tumor targets are selected from the one or more identified tumors. A sum of longitudinal diameters of the selected tumor targets is determined using the one or more machine learning based networks as the tumor burden.

In one embodiment, a tumor score is determined for each of the one or more identified tumors using a machine learning based tumor score network. A tumor burden is determined based on the tumor scores using a machine learning based tumor burden network.

In one embodiment, the tumor burdens of the patient determined for each of the plurality of points in time are compared. The one or more tumors are classified as one of complete response, partial response, stable disease, progressive disease based on the comparison.

In one embodiment, the plurality of input medical images comprises PCCT (photon-counting computed tomography) images. The plurality of input medical images may comprise images of a chest, an abdomen, and pelvis of the patient.

In one embodiment, the results of the assessment of the one or more tumors are displayed on a display device of a computing system.

These and other advantages of the invention will be apparent to those of ordinary skill in the art by reference to the following detailed description and the accompanying drawings.

### BRIEF DESCRIPTION OF THE DRAWINGS

FIG. 1 shows a method for performing an assessment of one or more tumors of a patient, in accordance with one or more embodiments;

FIG. 2 shows a workflow for performing an assessment of one or more tumors of a patient, in accordance with one or more embodiments;

FIG. 3 shows a table of systems utilized for performing the workflow of FIG. 2, in accordance with one or more embodiments;

FIG. 4 shows a comparison between a CT (computed tomography) image and a PCCT image, in accordance with one or more embodiments;

FIG. 5 shows a table illustrating detection of tumor diameter change with CT images and PCCT images, in accordance with one or more embodiments

FIG. 6 shows an exemplary artificial neural network that may be used to implement one or more embodiments;

FIG. 7 shows a convolutional neural network that may be used to implement one or more embodiments; and

FIG. 8 shows a high-level block diagram of a computer that may be used to implement one or more embodiments.

### DETAILED DESCRIPTION

The present invention generally relates to methods and systems for an AI/ML-based workflow for the assessment of tumors from medical images. Embodiments of the present invention are described herein to give a visual understanding of such methods and systems. A digital image is often composed of digital representations of one or more objects (or shapes). The digital representation of an object is often described herein in terms of identifying and manipulating the objects. Such manipulations are virtual manipulations accomplished in the memory or other circuitry/hardware of a computer system. Accordingly, is to be understood that embodiments of the present invention may be performed within a computer system using data stored within the computer system.

Embodiments described herein provide for the automatic assessment of tumors of a patient using various AI/ML-based networks. Such automatic assessment of tumors may be performed according to RECIST, an extended version of RECIST, or any other suitable criteria. Advantageously, the automatic assessment of tumors in accordance with embodiments described herein overcomes the problems associated with manual measurements of tumors and thus enables a more accurate assessment of tumors in accordance with RECIST. The automatic assessment of tumors in accordance with embodiments described herein further enables an extended version of RECIST for an even more accurate assessment of tumors which may not be practical with manual measurements on tumors, particularly for the detection of small, fast-growing tumors.

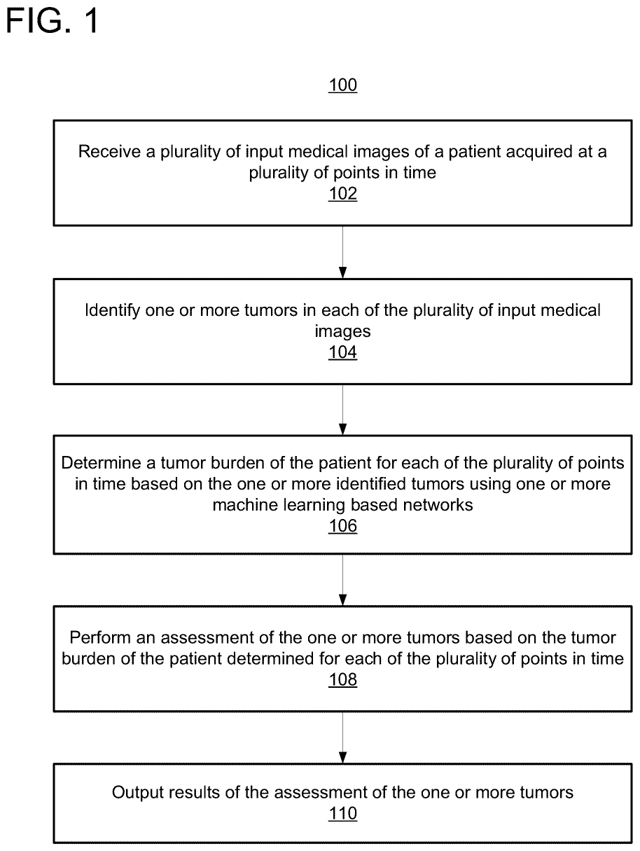

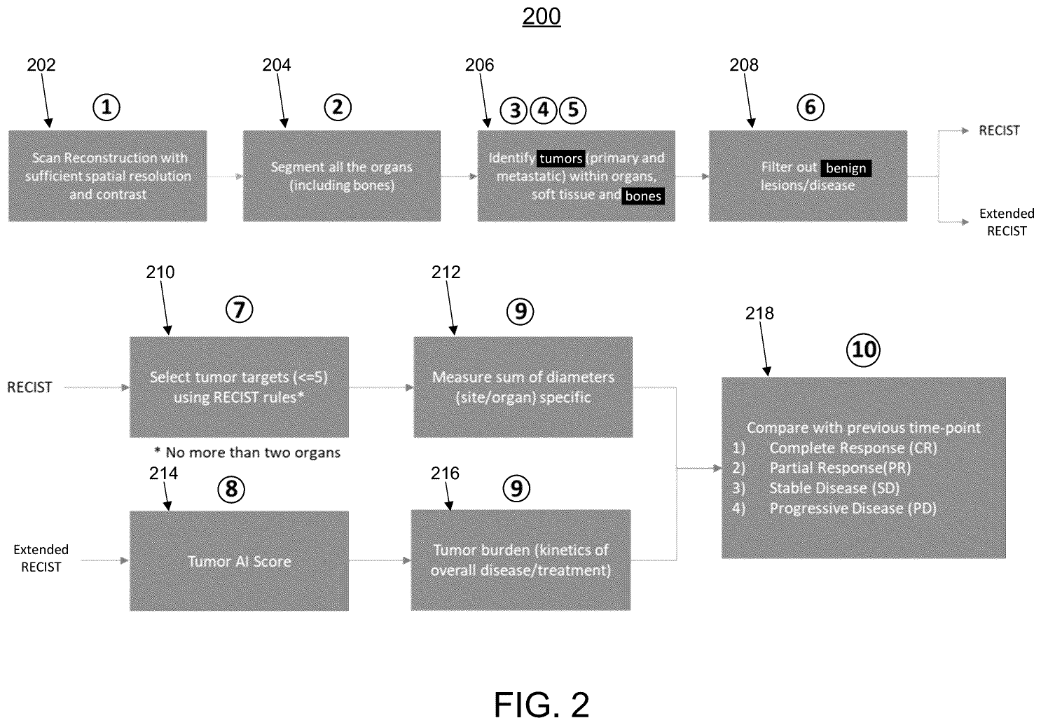

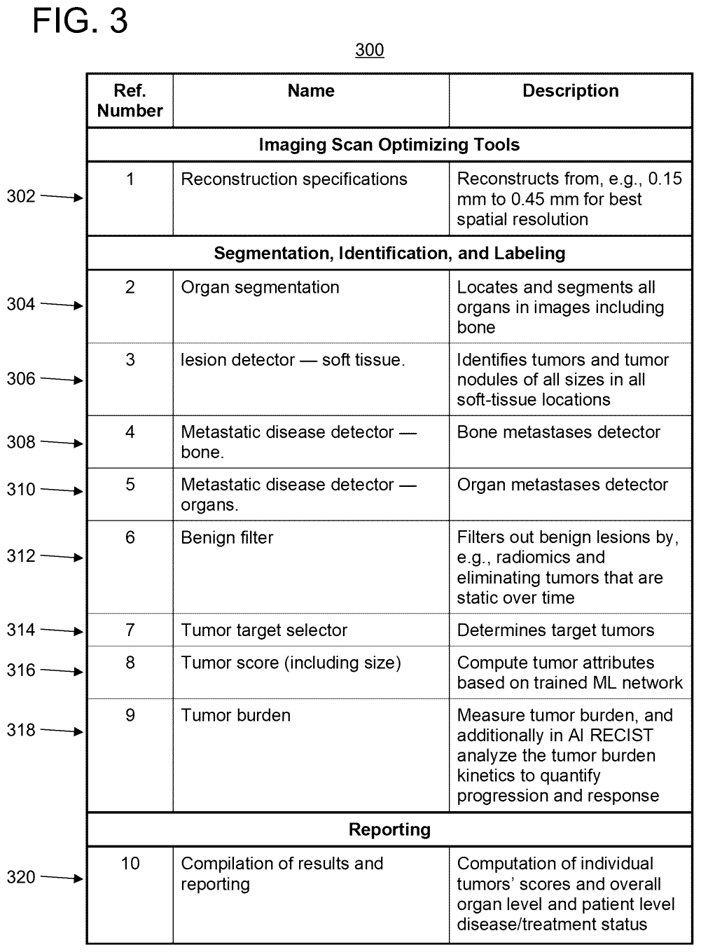

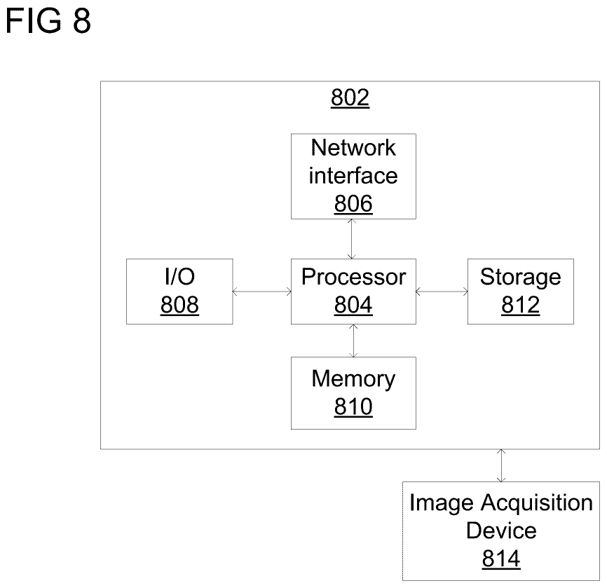

FIG. 1 shows a method 100 for performing an assessment of one or more tumors of a patient, in accordance with one or more embodiments. The steps of method 100 may be performed by one or more suitable computing devices, such as, e.g., computer 802 of FIG. 8. FIG. 2 shows a workflow 200 for performing an assessment of one or more tumors of a patient and FIG. 3 shows a table 300 of systems utilized for performing workflow 200 of FIG. 2, in accordance with one or more embodiments. The steps of workflow 200 are performed using one or more systems identified by reference numbers (represented as a number within a circle in FIG. 2) for each step and defined in table 300. The systems in table 300 may be implemented using AI/ML-based networks, algorithms, a set of rules, or any other suitable approach. FIGS. 1-3 will be described together.

At step 102 of FIG. 1, a plurality of input medical images of a patient acquired at a plurality of points in time are received. The plurality of input medical images depicts one or more tumors. The one or more tumors may comprise lesions, nodules, or any other abnormalities.

The plurality of input medical images may comprise an initial set of medical image(s) and one or more follow-up sets of medical image(s). The initial set of medical images depict the tumors at a first point in time. The one or more follow-up sets of medical images depict the tumors at one or more respective future points in time (after the first point in time).

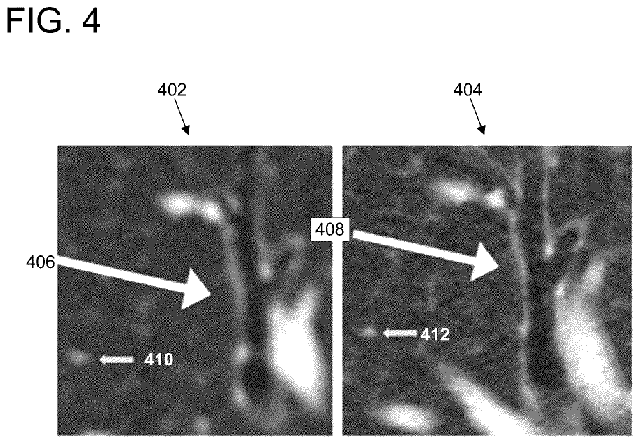

In one embodiment, the plurality of input medical images comprises PCCT (photon-counting computed tomography) images acquired using PCCT scanners equipped with photon-counting detectors for registering interactions of individual photons. An exemplary PCCT image 404 is shown in FIG. 4. However, the plurality of input medical images may be of any other suitable modality, such as, e.g., CT, MRI (magnetic resonance imaging), ultrasound, x-ray, or any other medical imaging modality or combinations of medical imaging modalities. The plurality of input medical images may comprise 2D (two dimensional) images and/or 3D (three dimensional) volumes. The plurality of input medical images may be received directly from an image acquisition device (e.g., image acquisition device 814 of FIG. 8), such as, e.g., a PCCT scanner, as the medical images are acquired, by loading previously acquired medical images from a storage or memory of a computer system, or by receiving medical images from a remote computer system.

In one embodiment, the plurality of input medical images may be received at step 102 of FIG. 1 by receiving raw imaging data from the image acquisition device and reconstructing the medical images from the raw imaging data. For example, as shown in workflow 200 of FIG. 2, scan reconstruction is performed at step 202 to reconstruct medical images with sufficient spatial resolution and contrast. Step 202 of FIG. 2 is performed using the system corresponding to reference number 1, which is defined at row 302 of table 300 of FIG. 3 as being a reconstruction specifications system for reconstructing medical images having a spatial resolution between, e.g., 0.15 to 0.45 millimeters.

At step 104 of FIG. 1, one or more tumors are identified in each of the plurality of input medical images. The one or more tumors may be identified using any suitable approach.

In one embodiment, as shown in workflow 200 of FIG. 2, the one or more tumors are identified by first segmenting all organs (including bones) from the plurality of input medical images at step 204. Step 204 of FIG. 2 is performed using the system corresponding to reference number 2, which is defined at row 304 of table 300 of FIG. 3 as being an organ segmentation system for locating and segmenting all organs in the input medical images. In one embodiment, the organ segmentation system may be a (e.g., known) AI/ML-based organ segmentation network, such as, e.g., an adversarially trained Image2Image Network. At step 206, the tumors (primary and metastatic) are then identified within the organs and other soft-tissue locations based on the segmentations. Step 206 of FIG. 2 is performed using the systems corresponding to reference numbers 3, 4, and 5. Reference number 3 is defined at row 306 of table 300 of FIG. 3 as being a soft tissue lesion detector for identifying tumors (including tumor nodules) of all sizes in all soft-tissue locations. Reference number 4 is defined at row 308 of table 300 of FIG. 3 as being a metastatic disease detector for detecting bone metastases. Reference number 5 is defined at row 310 of table 300 of FIG. 3 as being a metastatic disease detector for detecting organ metastases. At step 208, the identified tumors are then filtered to remove benign tumors. Step 208 of FIG. 2 is performed using the system corresponding to reference number 6, which is defined at row 312 of table 300 of FIG. 3 as being a benign filter system for filtering out benign tumors by radiomics and eliminating tumors that are static over time. The soft tissue lesion detector, the bone metastatic disease detector, the organ metastatic disease detector, and the benign filter systems may be implemented using AI/ML-based networks.

At step 106 of FIG. 1, a tumor burden of the patient is determined for each of the plurality of points in time based on the one or more identified tumors using one or more machine learning based networks. The tumor burden represents the total amount of cancer in the patient. In one embodiment, the tumor burden may be based on the size of tumors in the patient. As shown in FIG. 2, workflow 200 may proceed from step 208 to steps 210 and 212 to determine the tumor burden of the patient according to a RECIST workflow and/or may proceed from step 208 to steps 214 and 216 to determine the tumor burden of the patient according to an Extended RECIST workflow.

In the RECIST workflow, at step 210, tumor targets are selected from the one or more identified tumors according to RECIST rules. Under RECIST rules, up to five target tumors are selected from no more than two organs. Step 210 of FIG. 2 is performed using the system corresponding to reference number 7, which is defined at row 314 of table 300 of FIG. 3 as being a tumor target selector system for determining the target tumors. The tumor target selector system may be implemented as a set of rules or an algorithm for identifying the target tumors according to RECIST criteria. At step 212, the tumor burden is then determined as the sum of the longitudinal diameters of the identified tumor targets for each specific site/organ. Step 212 of FIG. 2 is performed using the system corresponding to reference number 9, which is defined at row 318 of table 300 of FIG. 3 as being a tumor burden system for measuring a tumor burden. The tumor burden system may be implemented as an AI/ML-based network for longitudinal analysis of tumor attributes for disease and treatment quantification. For example, the tumor burden system may be applied at step 212 for determining the diameters of the selected tumor targets.

In the Extended RECIST workflow, the RECIST workflow is extended to include additional measurements enabled by the automatic measurements of tumor features. At step 214, a tumor score is determined for each of the one or more identified tumors. Step 214 of FIG. 2 is performed using the system corresponding to reference number 8, which is defined at row 316 of table 300 of FIG. 3 as being a tumor score system for computing tumor attributes. The tumor score system may be implemented as an AI/ML-based network trained to extract important tumor attributes (e.g., size, volume, etc.) predictive of disease progression and treatment response and generate a tumor score based on the extract tumor attributes. The tumor score may be determined based on radiomics or directly from the imaging data. At step 216, the tumor burden is then determined based on the tumor scores. Step 216 of FIG. 2 is performed using the system corresponding to reference number 9, which is defined at row 318 of table 300 of FIG. 3 as being a tumor burden system for measuring a tumor burden. In the Extended RECIST workflow, the tumor burden system analyzes the tumor burden kinetics to quantify progression and response.

At step 108 of FIG. 1, an assessment of the one or more tumors is performed based on the tumor burden of the patient determined for each of the plurality of points in time. In one example, as shown in FIG. 2, workflow 200 proceeds from step 212 or from step 216 to step 218 to perform the assessment of the one or more tumors. In one embodiment, the assessment of the one or more tumors is performed at step 218 by comparing the tumor burdens of the patient determined for each of the plurality of points in time to, for example, determine a treatment response. The one or more tumors can then be classified as one of complete response, partial response, stable disease, progressive disease based on the comparison. Step 218 of FIG. 2 is performed using the system corresponding to reference number 10, which is defined at row 320 of table 300 of FIG. 3 as being a compilation and reporting system for compiling individual tumors' scores and overall organ level and patient level disease/treatment status.

At step 110 of FIG. 1, results of the assessment of the one or more tumors are output. The results of the assessment may include individual tumor diameters, individual tumor scores, and/or the tumor burden at the plurality of points in time. The results of the assessment can be output by, for example, displaying the results of the assessment on a display device (I/O device 808 of FIG. 8) device of a computer system, storing the results of the assessment on a memory or storage of a computer system, or by transmitting the results of the assessment to a remote computer system. In one embodiment, the tumor burdens for each of the plurality of points in time may be displayed and compared on the display device.

Advantageously, embodiments described herein provide for the automatic assessment of one or more tumors. Embodiments described herein enable an Extended RECIST workflow to analyze an entire PCCT scan (including chest, abdomen, and pelvis) of the patient for each point in time and record the presence and size of all suspected metastatic disease, not just the selected target tumors as in the RECIST workflow. Because of the resolution of the PCCT images, the Extended RECIST workflow can detect and measure the growth of all tumors starting at, e.g., 3 millimeters along with other lesion characteristics, three doubling times earlier than a RECIST workflow analyzing CT images which may detect tumors starting at, e.g., 6 millimeters (it takes three doubling times for a tumor to increase from 3 millimeters in diameter to 6 millimeters). The 3 millimeters tumors detected in accordance with embodiments described herein may be easily sterilized, e.g., using SABR (stereotactic ablative radiotherapy).

FIG. 4 shows a comparison between a CT (computed tomography) image 402 and a PCCT image 404, in accordance with one or more embodiments. CT image 402 and/or PCCT image 404 may be examples of the plurality of input medical images received at step 102 of FIG. 1. PCCT image 404 was acquired using a 150-micrometer spatial resolution scanner. CT image 402 and PCCT image 404 respectively depict a bronchus 406 and 408 and a small tumor 410 and 412. As shown in FIG. 4, PCCT image 404 has improved signal (and contrast) to noise ratio, reduced x-ray dose to the patient, improved spatial resolution, and the ability to distinguish multiple contrast agents, as compared to CT image 402.

With PCCT image 404, the smallest size tumor that could have its growth rate measured depends on the tumor doubling time, the time interval between serial PCCT scans, and the resolution of the scanner. For simplicity, it is assumed that a rapid tumor doubling time is 50 days and an average doubling time is 150 days for all tumors. It is also assumed that the scan is performed every 8 weeks during treatment.

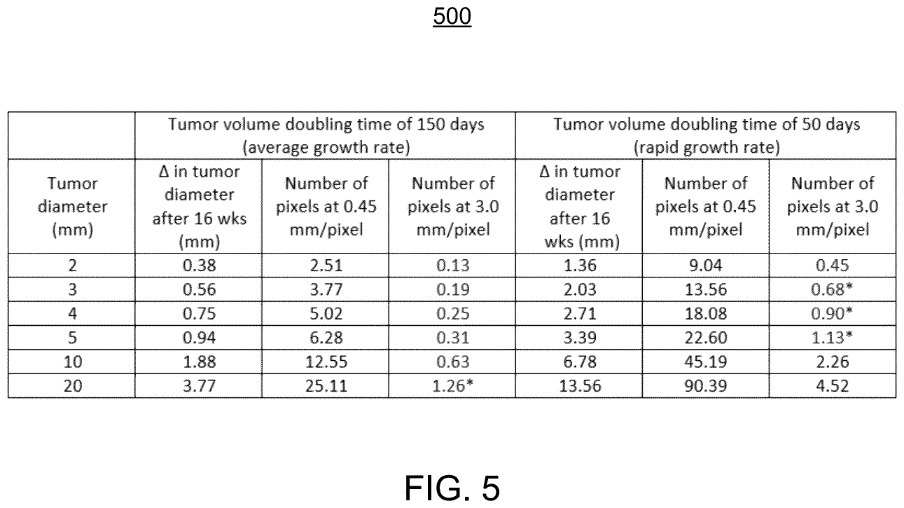

FIG. 5 shows a table 500 illustrating detection of tumor diameter change with CT images and PCCT images, in accordance with one or more embodiments. It is assumed that the images are reconstructed at ⅓ the ultimate resolution of the scanner and the time between scans is 16 weeks or four cycles of chemotherapy.

As shown in table 500, the detection of change in tumor diameters is analyzed for a tumor volume doubling time of 150 days (average growth rate) and a tumor volume doubling time of 50 days (rapid growth rate), for an initial tumor diameter between 2 and 20 mm (millimeters). The change in tumor diameter after 16 weeks is simulated and the corresponding number of pixels at 0.45 mm/pixel and the corresponding number of pixels at 3.0 mm/pixel are shown. The number of pixels at 0.45 mm/pixel corresponds to the PCCT images and the number of pixels at 3.0 mm/pixel corresponds to CT images. For the average growth rate, the number of pixels at 3.0 mm/pixel are less than a two pixel change for all tumor diameters 2 mm to 20 mm, meaning that the change in tumor diameter for tumors starting at 2 mm to 20 mm is too small to be measured from CT images. For the rapid growth rate, the number of pixels at 3.0 mm/pixel are less than a two pixel change for initial tumor diameters 2 mm to 5 mm, meaning that the change in tumor diameter for tumors starting at 2 mm to 5 mm is too small to be measured from CT images while the change in tumor diameter for tumors starting at 10 mm and 20 mm are above a 2 pixel change and are therefore able to be measured. For both the average growth rate and the rapid growth rate, the number of pixels at 0.45 mm/pixel are all above a two pixel change for all initial tumor diameters 2 mm to 20 mm and are therefore able to be measured.

According to table 500, the changes in rapid growing 10 mm tumors (which is the RECIST minimum) are possible to be measured after 16 weeks but not likely at 8 weeks apart. Table 500 suggests that changes to tumor diameter for tumors with as small as 3 mm diameters may be measured according to the Extended RECIST.

Embodiments described herein are described with respect to the claimed systems as well as with respect to the claimed methods. Features, advantages or alternative embodiments herein can be assigned to the other claimed objects and vice versa. In other words, claims for the systems can be improved with features described or claimed in the context of the methods. In this case, the functional features of the method are embodied by objective units of the providing system.

Furthermore, certain embodiments described herein are described with respect to methods and systems utilizing trained machine learning based models, as well as with respect to methods and systems for training machine learning based models. Features, advantages or alternative embodiments herein can be assigned to the other claimed objects and vice versa. In other words, claims for methods and systems for training a machine learning based model can be improved with features described or claimed in context of the methods and systems for utilizing a trained machine learning based model, and vice versa.

In particular, the trained machine learning based models applied in embodiments described herein can be adapted by the methods and systems for training the machine learning based models. Furthermore, the input data of the trained machine learning based model can comprise advantageous features and embodiments of the training input data, and vice versa. Furthermore, the output data of the trained machine learning based model can comprise advantageous features and embodiments of the output training data, and vice versa.

In general, a trained machine learning based model mimics cognitive functions that humans associate with other human minds. In particular, by training based on training data, the trained machine learning based model is able to adapt to new circumstances and to detect and extrapolate patterns.

In general, parameters of a machine learning based model can be adapted by means of training. In particular, supervised training, semi-supervised training, unsupervised training, reinforcement learning and/or active learning can be used. Furthermore, representation learning (an alternative term is “feature learning”) can be used. In particular, the parameters of the trained machine learning based model can be adapted iteratively by several steps of training.

In particular, a trained machine learning based model can comprise a neural network, a support vector machine, a decision tree, and/or a Bayesian network, and/or the trained machine learning based model can be based on k-means clustering, Q-learning, genetic algorithms, and/or association rules. In particular, a neural network can be a deep neural network, a convolutional neural network, or a convolutional deep neural network. Furthermore, a neural network can be an adversarial network, a deep adversarial network and/or a generative adversarial network.

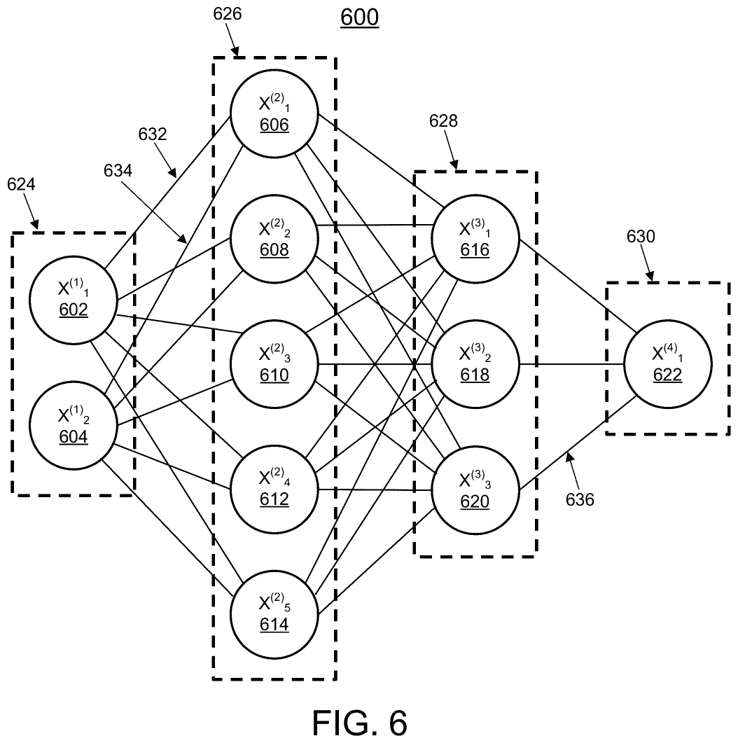

FIG. 6 shows an embodiment of an artificial neural network 600, in accordance with one or more embodiments. Alternative terms for “artificial neural network” are “neural network”, “artificial neural net” or “neural net”. Machine learning networks described herein, such as, e.g., the one or more machine learning based networks utilized at step 106 of FIG. 1, the systems utilized for performing the steps of FIG. 2, and the systems defined in FIG. 3, may be implemented using artificial neural network 600.

The artificial neural network 600 comprises nodes 602-622 and edges 632, 634, . . . , 636, wherein each edge 632, 634, . . . , 636 is a directed connection from a first node 602-622 to a second node 602-622. In general, the first node 602-622 and the second node 602-622 are different nodes 602-622, it is also possible that the first node 602-622 and the second node 602-622 are identical. For example, in FIG. 6, the edge 632 is a directed connection from the node 602 to the node 606, and the edge 634 is a directed connection from the node 604 to the node 606. An edge 632, 634, . . . , 636 from a first node 602-622 to a second node 602-622 is also denoted as “ingoing edge” for the second node 602-622 and as “outgoing edge” for the first node 602-622.

In this embodiment, the nodes 602-622 of the artificial neural network 600 can be arranged in layers 624-630, wherein the layers can comprise an intrinsic order introduced by the edges 632, 634, . . . , 636 between the nodes 602-622. In particular, edges 632, 634, . . . , 636 can exist only between neighboring layers of nodes. In the embodiment shown in FIG. 6, there is an input layer 624 comprising only nodes 602 and 604 without an incoming edge, an output layer 630 comprising only node 622 without outgoing edges, and hidden layers 626, 628 in-between the input layer 624 and the output layer 630. In general, the number of hidden layers 626, 628 can be chosen arbitrarily. The number of nodes 602 and 604 within the input layer 624 usually relates to the number of input values of the neural network 600, and the number of nodes 622 within the output layer 630 usually relates to the number of output values of the neural network 600.

In particular, a (real) number can be assigned as a value to every node 602-622 of the neural network 600. Here, x⁽ⁿ⁾ᵢ denotes the value of the i-th node 602-622 of the n-th layer 624-630. The values of the nodes 602-622 of the input layer 624 are equivalent to the input values of the neural network 600, the value of the node 622 of the output layer 630 is equivalent to the output value of the neural network 600. Furthermore, each edge 632, 634, . . . , 636 can comprise a weight being a real number, in particular, the weight is a real number within the interval [−1, 1] or within the interval [0, 1]. Here, w^{(m,n)}_{i,j} denotes the weight of the edge between the i-th node 602-622 of the m-th layer 624-630 and the j-th node 602-622 of the n-th layer 624-630. Furthermore, the abbreviation w⁽ⁿ⁾_{i,j} is defined for the weight w^{(n,n+1)}_{i,j}.

In particular, to calculate the output values of the neural network 600, the input values are propagated through the neural network. In particular, the values of the nodes 602-622 of the (n+1)-th layer 624-630 can be calculated based on the values of the nodes 602-622 of the n-th layer 624-630 by

$${x}_{j}^{( n + 1 )} = f ( {\sum }_{i} {x}_{i}^{( n )} \cdot {w}_{i , j}^{( n )} ) .$$

Herein, the function f is a transfer function (another term is “activation function”). Known transfer functions are step functions, sigmoid function (e.g. the logistic function, the generalized logistic function, the hyperbolic tangent, the Arctangent function, the error function, the smoothstep function) or rectifier functions. The transfer function is mainly used for normalization purposes.

In particular, the values are propagated layer-wise through the neural network, wherein values of the input layer 624 are given by the input of the neural network 600, wherein values of the first hidden layer 626 can be calculated based on the values of the input layer 624 of the neural network, wherein values of the second hidden layer 628 can be calculated based in the values of the first hidden layer 626, etc.

In order to set the values w^{(m,n)}_{i,j} for the edges, the neural network 600 has to be trained using training data. In particular, training data comprises training input data and training output data (denoted as tᵢ). For a training step, the neural network 600 is applied to the training input data to generate calculated output data. In particular, the training data and the calculated output data comprise a number of values, said number being equal with the number of nodes of the output layer.

In particular, a comparison between the calculated output data and the training data is used to recursively adapt the weights within the neural network 600 (backpropagation algorithm). In particular, the weights are changed according to

$${w}_{i , j}^{′ ( n )} = {w}_{i , j}^{( n )} - γ \cdot {δ}_{j}^{( n )} \cdot {x}_{i}^{( n )}$$

wherein γ is a learning rate, and the numbers δ⁽ⁿ⁾ⱼ can be recursively calculated as

$${δ}_{j}^{( n )} = ( {\sum }_{k} {δ}_{k}^{( n + 1 )} \cdot {w}_{j , k}^{( n + 1 )} ) \cdot {f}^{′} ( {\sum }_{i} {x}_{i}^{( n )} \cdot {w}_{i , j}^{( n )} )$$

based on δ⁽ⁿ⁺¹⁾ⱼ, if the (n+1)-th layer is not the output layer, and

$${δ}_{j}^{( n )} = ( {x}_{k}^{( n + 1 )} - {t}_{j}^{( n + 1 )} ) \cdot {f}^{′} ( {\sum }_{i} {x}_{i}^{( n )} \cdot {w}_{i , j}^{( n )} )$$

if the (n+1)-th layer is the output layer 630, wherein f′ is the first derivative of the activation function, and y⁽ⁿ⁺¹⁾ⱼ is the comparison training value for the j-th node of the output layer 630.

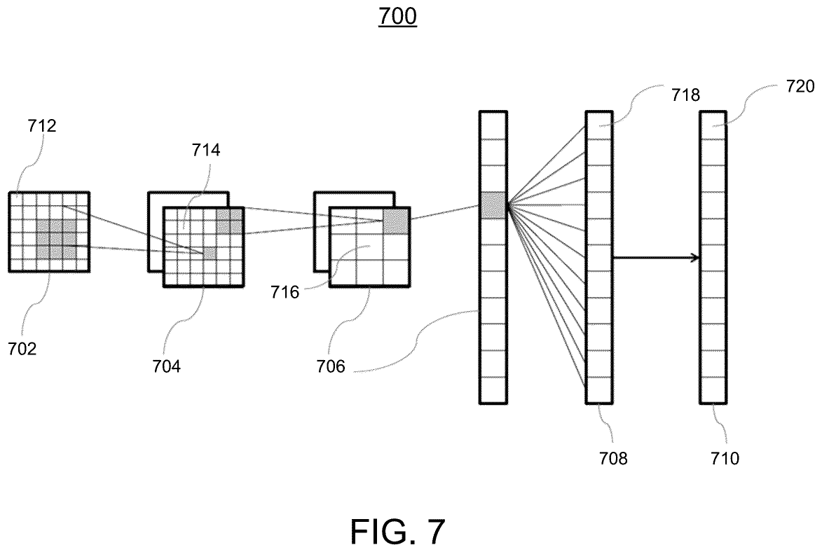

FIG. 7 shows a convolutional neural network 700, in accordance with one or more embodiments. Machine learning networks described herein, such as, e.g., the one or more machine learning based networks utilized at step 106 of FIG. 1, the systems utilized for performing the steps of FIG. 2, and the systems defined in FIG. 3, may be implemented using convolutional neural network 700.

In the embodiment shown in FIG. 7, the convolutional neural network comprises 700 an input layer 702, a convolutional layer 704, a pooling layer 706, a fully connected layer 708, and an output layer 710. Alternatively, the convolutional neural network 700 can comprise several convolutional layers 704, several pooling layers 706, and several fully connected layers 708, as well as other types of layers. The order of the layers can be chosen arbitrarily, usually fully connected layers 708 are used as the last layers before the output layer 710.

In particular, within a convolutional neural network 700, the nodes 712-720 of one layer 702-710 can be considered to be arranged as a d-dimensional matrix or as a d-dimensional image. In particular, in the two-dimensional case the value of the node 712-720 indexed with i and j in the n-th layer 702-710 can be denoted as x⁽ⁿ⁾_{[i,j]}. However, the arrangement of the nodes 712-720 of one layer 702-710 does not have an effect on the calculations executed within the convolutional neural network 700 as such, since these are given solely by the structure and the weights of the edges.

In particular, a convolutional layer 704 is characterized by the structure and the weights of the incoming edges forming a convolution operation based on a certain number of kernels. In particular, the structure and the weights of the incoming edges are chosen such that the values x⁽ⁿ⁾ₖ of the nodes 714 of the convolutional layer 704 are calculated as a convolution x⁽ⁿ⁾ₖ=Kₖ*x⁽ⁿ⁻¹⁾ based on the values x⁽ⁿ⁻¹⁾ of the nodes 712 of the preceding layer 702, where the convolution * is defined in the two-dimensional case as

$${x}_{k}^{( n )} [ i , j ] = ( {K}_{k} * {x}^{( n - 1 )} ) [ i , j ] = {\sum }_{{i}^{′}} {\sum }_{{j}^{′}} {K}_{k} [ {i}^{′} , {j}^{′} ] \cdot {x}^{( n - 1 )} [ i - {i}^{′} , j - {j}^{′} ] .$$

Here the k-th kernel Kₖ is a d-dimensional matrix (in this embodiment a two-dimensional matrix), which is usually small compared to the number of nodes 712-718 (e.g. a 3×3 matrix, or a 5×5 matrix). In particular, this implies that the weights of the incoming edges are not independent, but chosen such that they produce said convolution equation. In particular, for a kernel being a 3×3 matrix, there are only 9 independent weights (each entry of the kernel matrix corresponding to one independent weight), irrespectively of the number of nodes 712-720 in the respective layer 702-710. In particular, for a convolutional layer 704, the number of nodes 714 in the convolutional layer is equivalent to the number of nodes 712 in the preceding layer 702 multiplied with the number of kernels.

If the nodes 712 of the preceding layer 702 are arranged as a d-dimensional matrix, using a plurality of kernels can be interpreted as adding a further dimension (denoted as “depth” dimension), so that the nodes 714 of the convolutional layer 704 are arranged as a (d+1)-dimensional matrix. If the nodes 712 of the preceding layer 702 are already arranged as a (d+1)-dimensional matrix comprising a depth dimension, using a plurality of kernels can be interpreted as expanding along the depth dimension, so that the nodes 714 of the convolutional layer 704 are arranged also as a (d+1)-dimensional matrix, wherein the size of the (d+1)-dimensional matrix with respect to the depth dimension is by a factor of the number of kernels larger than in the preceding layer 702.

The advantage of using convolutional layers 704 is that spatially local correlation of the input data can exploited by enforcing a local connectivity pattern between nodes of adjacent layers, in particular by each node being connected to only a small region of the nodes of the preceding layer.

In embodiment shown in FIG. 7, the input layer 702 comprises 36 nodes 712, arranged as a two-dimensional 6×6 matrix. The convolutional layer 704 comprises 72 nodes 714, arranged as two two-dimensional 6×6 matrices, each of the two matrices being the result of a convolution of the values of the input layer with a kernel. Equivalently, the nodes 714 of the convolutional layer 704 can be interpreted as arranges as a three-dimensional 6×6×2 matrix, wherein the last dimension is the depth dimension.

A pooling layer 706 can be characterized by the structure and the weights of the incoming edges and the activation function of its nodes 716 forming a pooling operation based on a non-linear pooling function f. For example, in the two dimensional case the values x⁽ⁿ⁾ of the nodes 716 of the pooling layer 706 can be calculated based on the values x⁽ⁿ⁻¹⁾ of the nodes 714 of the preceding layer 704 as

$${x}^{( n )} [ i , j ] = f ( {x}^{( n - 1 )} [ {id}_{1} , {jd}_{2} ] , ... , {x}^{( n - 1 )} [ {id}_{1} + {d}_{1} - 1 , {jd}_{2} + {d}_{2} - 1 ] )$$

In other words, by using a pooling layer 706, the number of nodes 714, 716 can be reduced, by replacing a number d1·d2 of neighboring nodes 714 in the preceding layer 704 with a single node 716 being calculated as a function of the values of said number of neighboring nodes in the pooling layer. In particular, the pooling function f can be the max-function, the average or the L2-Norm. In particular, for a pooling layer 706 the weights of the incoming edges are fixed and are not modified by training.

The advantage of using a pooling layer 706 is that the number of nodes 714, 716 and the number of parameters is reduced. This leads to the amount of computation in the network being reduced and to a control of overfitting.

In the embodiment shown in FIG. 7, the pooling layer 706 is a max-pooling, replacing four neighboring nodes with only one node, the value being the maximum of the values of the four neighboring nodes. The max-pooling is applied to each d-dimensional matrix of the previous layer; in this embodiment, the max-pooling is applied to each of the two two-dimensional matrices, reducing the number of nodes from 72 to 18.

A fully-connected layer 708 can be characterized by the fact that a majority, in particular, all edges between nodes 716 of the previous layer 706 and the nodes 718 of the fully-connected layer 708 are present, and wherein the weight of each of the edges can be adjusted individually.

In this embodiment, the nodes 716 of the preceding layer 706 of the fully-connected layer 708 are displayed both as two-dimensional matrices, and additionally as non-related nodes (indicated as a line of nodes, wherein the number of nodes was reduced for a better presentability). In this embodiment, the number of nodes 718 in the fully connected layer 708 is equal to the number of nodes 716 in the preceding layer 706. Alternatively, the number of nodes 716, 718 can differ.

Furthermore, in this embodiment, the values of the nodes 720 of the output layer 710 are determined by applying the Softmax function onto the values of the nodes 718 of the preceding layer 708. By applying the Softmax function, the sum the values of all nodes 720 of the output layer 710 is 1, and all values of all nodes 720 of the output layer are real numbers between 0 and 1.

A convolutional neural network 700 can also comprise a ReLU (rectified linear units) layer or activation layers with non-linear transfer functions. In particular, the number of nodes and the structure of the nodes contained in a ReLU layer is equivalent to the number of nodes and the structure of the nodes contained in the preceding layer. In particular, the value of each node in the ReLU layer is calculated by applying a rectifying function to the value of the corresponding node of the preceding layer.

The input and output of different convolutional neural network blocks can be wired using summation (residual/dense neural networks), element-wise multiplication (attention) or other differentiable operators. Therefore, the convolutional neural network architecture can be nested rather than being sequential if the whole pipeline is differentiable.

In particular, convolutional neural networks 700 can be trained based on the backpropagation algorithm. For preventing overfitting, methods of regularization can be used, e.g. dropout of nodes 712-720, stochastic pooling, use of artificial data, weight decay based on the L1 or the L2 norm, or max norm constraints. Different loss functions can be combined for training the same neural network to reflect the joint training objectives. A subset of the neural network parameters can be excluded from optimization to retain the weights pretrained on another datasets.

Systems, apparatuses, and methods described herein may be implemented using digital circuitry, or using one or more computers using well-known computer processors, memory units, storage devices, computer software, and other components. Typically, a computer includes a processor for executing instructions and one or more memories for storing instructions and data. A computer may also include, or be coupled to, one or more mass storage devices, such as one or more magnetic disks, internal hard disks and removable disks, magneto-optical disks, optical disks, etc.

Systems, apparatus, and methods described herein may be implemented using computers operating in a client-server relationship. Typically, in such a system, the client computers are located remotely from the server computer and interact via a network. The client-server relationship may be defined and controlled by computer programs running on the respective client and server computers.

Systems, apparatus, and methods described herein may be implemented within a network-based cloud computing system. In such a network-based cloud computing system, a server or another processor that is connected to a network communicates with one or more client computers via a network. A client computer may communicate with the server via a network browser application residing and operating on the client computer, for example. A client computer may store data on the server and access the data via the network. A client computer may transmit requests for data, or requests for online services, to the server via the network. The server may perform requested services and provide data to the client computer(s). The server may also transmit data adapted to cause a client computer to perform a specified function, e.g., to perform a calculation, to display specified data on a screen, etc. For example, the server may transmit a request adapted to cause a client computer to perform one or more of the steps or functions of the methods and workflows described herein, including one or more of the steps or functions of FIG. 1 or 2. Certain steps or functions of the methods and workflows described herein, including one or more of the steps or functions of FIG. 1 or 2, may be performed by a server or by another processor in a network-based cloud-computing system. Certain steps or functions of the methods and workflows described herein, including one or more of the steps of FIG. 1 or 2, may be performed by a client computer in a network-based cloud computing system. The steps or functions of the methods and workflows described herein, including one or more of the steps of FIG. 1 or 2, may be performed by a server and/or by a client computer in a network-based cloud computing system, in any combination.

Systems, apparatus, and methods described herein may be implemented using a computer program product tangibly embodied in an information carrier, e.g., in a non-transitory machine-readable storage device, for execution by a programmable processor; and the method and workflow steps described herein, including one or more of the steps or functions of FIG. 1 or 2, may be implemented using one or more computer programs that are executable by such a processor. A computer program is a set of computer program instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

A high-level block diagram of an example computer 802 that may be used to implement systems, apparatus, and methods described herein is depicted in FIG. 8. Computer 802 includes a processor 804 operatively coupled to a data storage device 812 and a memory 810. Processor 804 controls the overall operation of computer 802 by executing computer program instructions that define such operations. The computer program instructions may be stored in data storage device 812, or other computer readable medium, and loaded into memory 810 when execution of the computer program instructions is desired. Thus, the method and workflow steps or functions of FIG. 1 or 2 can be defined by the computer program instructions stored in memory 810 and/or data storage device 812 and controlled by processor 804 executing the computer program instructions. For example, the computer program instructions can be implemented as computer executable code programmed by one skilled in the art to perform the method and workflow steps or functions of FIG. 1 or 2. Accordingly, by executing the computer program instructions, the processor 804 executes the method and workflow steps or functions of FIG. 1 or 2. Computer 802 may also include one or more network interfaces 806 for communicating with other devices via a network. Computer 802 may also include one or more input/output devices 808 that enable user interaction with computer 802 (e.g., display, keyboard, mouse, speakers, buttons, etc.).

Processor 804 may include both general and special purpose microprocessors, and may be the sole processor or one of multiple processors of computer 802. Processor 804 may include one or more central processing units (CPUs), for example. Processor 804, data storage device 812, and/or memory 810 may include, be supplemented by, or incorporated in, one or more application-specific integrated circuits (ASICs) and/or one or more field programmable gate arrays (FPGAs).

Data storage device 812 and memory 810 each include a tangible non-transitory computer readable storage medium. Data storage device 812, and memory 810, may each include high-speed random access memory, such as dynamic random access memory (DRAM), static random access memory (SRAM), double data rate synchronous dynamic random access memory (DDR RAM), or other random access solid state memory devices, and may include non-volatile memory, such as one or more magnetic disk storage devices such as internal hard disks and removable disks, magneto-optical disk storage devices, optical disk storage devices, flash memory devices, semiconductor memory devices, such as erasable programmable read-only memory (EPROM), electrically erasable programmable read-only memory (EEPROM), compact disc read-only memory (CD-ROM), digital versatile disc read-only memory (DVD-ROM) disks, or other non-volatile solid state storage devices.

I/O (input/output) devices 808 may include peripherals, such as a printer, scanner, display screen, etc. For example, input/output devices 808 may include a display device such as a cathode ray tube (CRT) or liquid crystal display (LCD) monitor for displaying information to the user, a keyboard, and a pointing device such as a mouse or a trackball by which the user can provide input to computer 802.

An image acquisition device 814 can be connected to the computer 802 to input image data (e.g., medical images) to the computer 802. It is possible to implement the image acquisition device 814 and the computer 802 as one device. It is also possible that the image acquisition device 814 and the computer 802 communicate wirelessly through a network. In a possible embodiment, the computer 802 can be located remotely with respect to the image acquisition device 814.

Any or all of the systems and apparatus discussed herein may be implemented using one or more computers such as computer 802.

One skilled in the art will recognize that an implementation of an actual computer or computer system may have other structures and may contain other components as well, and that FIG. 8 is a high level representation of some of the components of such a computer for illustrative purposes.

Independent of the grammatical term usage, individuals with male, female or other gender identities are included within the term.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A computer-implemented method comprising:
receiving a plurality of input medical images of a patient acquired at a plurality of points in time;
identifying one or more tumors in each of the plurality of input medical images;
determining a tumor burden of the patient for each of the plurality of points in time based on the one or more identified tumors using one or more machine learning based networks;
performing an assessment of the one or more tumors based on the tumor burden of the patient determined for each of the plurality of points in time; and
outputting results of the assessment of the one or more tumors.

2. The computer-implemented method of claim 1, wherein identifying one or more tumors in each of the plurality of input medical images comprises:
segmenting organs from the plurality of input medical images using a machine learning based segmentation network;
identifying at least one tumor within organs, soft tissue, and bones based on the segmented organs; and
filtering out benign tumors.

3. The computer-implemented method of claim 1, wherein determining a tumor burden of the patient for each of the plurality of points in time based on the one or more identified tumors using one or more machine learning based networks comprises:
selecting tumor targets from the one or more identified tumors; and
determining a sum of longitudinal diameters of the selected tumor targets using the one or more machine learning based networks as the tumor burden.

4. The computer-implemented method of claim 1, wherein determining a tumor burden of the patient for each of the plurality of points in time based on the one or more identified tumors using one or more machine learning based networks comprises:
determining a tumor score for each of the one or more identified tumors using a machine learning based tumor score network; and
determining the tumor burden based on the tumor scores using a machine learning based tumor burden network.

5. The computer-implemented method of claim 1, wherein performing an assessment of the one or more tumors based on the tumor burden of the patient determined for each of the plurality of points in time comprises:
comparing the tumor burdens of the patient determined for each of the plurality of points in time.

6. The computer-implemented method of claim 5, wherein performing an assessment of the one or more tumors based on the tumor burden of the patient determined for each of the plurality of points in time further comprises:
classifying the one or more tumors as one of complete response, partial response, stable disease, progressive disease based on the comparison.

7. The computer-implemented method of claim 1, wherein the plurality of input medical images comprises PCCT (photon-counting computed tomography) images.

8. The computer-implemented method of claim 1, wherein the plurality of input medical images comprises images of a chest, an abdomen, and pelvis of the patient.

9. The computer-implemented method of claim 1, wherein outputting results of the assessment of the one or more tumors comprises:
displaying the results of the assessment of the one or more tumors on a display device of a computing system.

10. An apparatus comprising:
means for receiving a plurality of input medical images of a patient acquired at a plurality of points in time;
means for identifying one or more tumors in each of the plurality of input medical images;
means for determining a tumor burden of the patient for each of the plurality of points in time based on the one or more identified tumors using one or more machine learning based networks;
means for performing an assessment of the one or more tumors based on the tumor burden of the patient determined for each of the plurality of points in time; and
means for outputting results of the assessment of the one or more tumors.

11. The apparatus of claim 10, wherein the means for identifying one or more tumors in each of the plurality of input medical images comprises:
means for segmenting organs from the plurality of input medical images using a machine learning based segmentation network;
means for identifying at least one tumor within organs, soft tissue, and bones based on the segmented organs; and
means for filtering out benign tumors.

12. The apparatus of claim 10, wherein the means for determining a tumor burden of the patient for each of the plurality of points in time based on the one or more identified tumors using one or more machine learning based networks comprises:
means for selecting tumor targets from the one or more identified tumors; and
means for determining a sum of longitudinal diameters of the selected tumor targets using the one or more machine learning based networks as the tumor burden.

13. The apparatus of claim 10, wherein the means for determining a tumor burden of the patient for each of the plurality of points in time based on the one or more identified tumors using one or more machine learning based networks comprises:
means for determining a tumor score for each of the one or more identified tumors using a machine learning based tumor score network; and
means for determining the tumor burden based on the tumor scores using a machine learning based tumor burden network.

14. The apparatus of claim 10, wherein the plurality of input medical images comprises PCCT (photon-counting computed tomography) images.

15. A non-transitory computer readable medium storing computer program instructions, the computer program instructions when executed by a processor cause the processor to perform operations comprising:
receiving a plurality of input medical images of a patient acquired at a plurality of points in time;
identifying one or more tumors in each of the plurality of input medical images;
determining a tumor burden of the patient for each of the plurality of points in time based on the one or more identified tumors using one or more machine learning based networks;
performing an assessment of the one or more tumors based on the tumor burden of the patient determined for each of the plurality of points in time; and
outputting results of the assessment of the one or more tumors.

16. The non-transitory computer readable medium of claim 15, wherein performing an assessment of the one or more tumors based on the tumor burden of the patient determined for each of the plurality of points in time comprises:
comparing the tumor burdens of the patient determined for each of the plurality of points in time.

17. The non-transitory computer readable medium of claim 16, wherein performing an assessment of the one or more tumors based on the tumor burden of the patient determined for each of the plurality of points in time further comprises:
classifying the one or more tumors as one of complete response, partial response, stable disease, progressive disease based on the comparison.

18. The non-transitory computer readable medium of claim 15, wherein the plurality of input medical images comprises PCCT (photon-counting computed tomography) images.

19. The non-transitory computer readable medium of claim 15, wherein the plurality of input medical images comprises images of a chest, an abdomen, and pelvis of the patient.

20. The non-transitory computer readable medium of claim 15, wherein outputting results of the assessment of the one or more tumors comprises:
displaying the results of the assessment of the one or more tumors on a display device of a computing system.
